(19) United States
(12) Patent Application Publication
(10) Pub. No.: US 2014/0077621 A1
(43) Pub. Date: Mar. 20, 2014

(54) SWITCHING CIRCUIT FOR ANTENNA

(71) Applicant: MAXTEK TECHNOLOGY CO., LTD., Taipei (TW)

(72) Inventors: Ke-Kung LIAO, Taipei (TW); Tung-Sheng CHANG, Taipei (TW); Chung-Yen KU, Taipei (TW); Shih-Yu CHEN, Taipei (TW)

(73) Assignee: MAXTEK TECHNOLOGY CO., LTD, Taipei (TW)

(21) Appl. No.: 13/758,234

(22) Filed: Feb. 4, 2013

(30) Foreign Application Priority Data
Sep. 14, 2012 (TW) 101133809

(51) Int. Cl. H01Q 1/50

(52) U.S. Cl. CPC H01Q 1/50
USPC 307/113

(57) ABSTRACT

A switching circuit for an antenna includes a first switching unit, a second switching unit, a third switching unit, a fourth switching unit, a first clamping unit and a second clamping unit. The first clamping unit is coupled to the first switching unit and the fourth switching unit. The first clamping unit includes a first clamping device and a first resistor, which are connected in parallel. The second clamping unit is coupled to the second switching unit and the third switching unit. The second clamping unit includes a second clamping device and a second resistor, which are connected in parallel.

### CROSS REFERENCE TO RELATED APPLICATIONS

This Non-provisional application claims priority under 35 U.S.C. §119(a) on Patent Application No(s). 101133809 filed in Taiwan, Republic of China on Sep. 14, 2012, the entire contents of which are hereby incorporated by reference.

### BACKGROUND OF THE INVENTION

1. Field of Invention

The present invention relates to a switching circuit and, in particular, to a switching circuit for an antenna.

2. Related Art

Due to the wide development of the wireless communication technology, the marketing demand for the antenna has been raised rapidly. Nowadays, the wireless communication apparatuses, such as cell phones, notebook computers, global positioning systems, digital televisions, and portable electronic apparatuses, rely on antennas for transmitting and receiving signals. In other words, the antenna is an essential device to the wireless communication apparatus for communicating with the outside world by transmitting and receiving wireless signals. The antenna configured for transmitting and receiving wireless signals gives enormous affection to the signal quality and the performance of the wireless communication.

Due to the different requirements, many areas have their respective wireless communication standards that comply with several frequency bands. For fitting more standards, it's getting common to design an antenna that can transmit and receive the signals of multiple frequency bands. In the circuit design, the multi-band effect can be achieved by separating different feed-in signals through a switching circuit.

Accordingly, the antenna switching circuit also affects the signal quality and the performance of the antenna. Therefore, it is an important subject to provide a switching circuit for an antenna that can improve the voltage-resistant level and anti-noise ability of the antenna switching circuit so as to improve the signal quality of the antenna.

### SUMMARY OF THE INVENTION

In view of the foregoing subject, an objective of the present invention is to provide a switching circuit for an antenna that can improve the voltage-resistant level and anti-noise ability of the antenna switching circuit so as to improve the signal quality of the antenna.

To achieve the above objective, the present invention discloses a switching circuit for an antenna, which includes a first switching unit, a second switching unit, a third switching unit, a fourth switching unit, a first clamping unit and a second clamping unit. The first switching unit is coupled to a first signal terminal and a second signal terminal. The second switching unit is coupled to the second signal terminal and a third signal terminal. The third switching unit is coupled to the first signal terminal and the first switching unit. The fourth switching unit is coupled to the third signal terminal and the second switching unit. The first clamping unit is coupled to the first switching unit and the fourth switching unit, and the first clamping unit comprises a first clamping device and a first resistor, which are connected in parallel. The second clamping unit is coupled to the second switching unit and the third switching unit, and the second clamping unit comprises a second clamping device and a second resistor, which are connected in parallel.

In one embodiment, the first switching unit comprises a first switch device having a first terminal coupled to the first signal terminal, a second terminal coupled to the second signal terminal, and a third terminal coupled to the first clamping unit.

In one embodiment, the second switching unit comprises a second switch device having a first terminal coupled to the third signal terminal, a second terminal coupled to the second signal terminal, and a third terminal coupled to the second clamping unit.

In one embodiment, the first clamping unit further comprises a third resistor and a fourth resistor. The third resistor has a first terminal coupled to the first clamping device and the first resistor, and a second terminal coupled to the first switching unit. The fourth resistor has a first terminal coupled to the first clamping device and the first resistor, and a second terminal coupled to the fourth switching unit.

In one embodiment, the second clamping unit further comprises a fifth resistor and a sixth resistor. The fifth resistor has a first terminal coupled to the second clamping device and the second resistor, and a second terminal coupled to the second switching unit. The sixth resistor has a first terminal coupled to the second clamping device and the second resistor, and a second terminal coupled to the third switching unit.

In one embodiment, the third switching unit comprises a third switch device, a seventh resistor and a first capacitor. The third switch device has a first terminal coupled to the first signal terminal, a second terminal coupled to the sixth resistor and a second power source via the seventh resistor, and a third terminal coupled to a ground terminal via the first capacitor.

In one embodiment, the fourth switching unit comprises a fourth switch device, an eighth resistor and a second capacitor. The fourth switch device has a first terminal coupled to the third signal terminal, a second terminal coupled to the fourth resistor and a first power source via the eighth resistor, and a third terminal coupled to the ground terminal via the second capacitor.

In one embodiment, each of the first clamping device and the second clamping device is a Schottky diode.

As mentioned above, the switching circuit for an antenna of the present invention includes a first clamping unit and a second clamping unit. The configuration of the first and second clamping units can improve the voltage-resistant level and anti-noise ability of the antenna switching circuit so as to improve the signal quality of the antenna, thereby bringing the extremely high marketing potential.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a circuit block diagram of a switching circuit for an antenna according to a preferred embodiment of the present invention;

FIG. 2 is a circuit diagram of a switching circuit for an antenna according to another preferred embodiment of the present invention;

FIG. 3 is a circuit diagram of a switching circuit for an antenna according to another preferred embodiment of the present invention; and

FIG. 4 is a circuit diagram of a switching circuit for an antenna according to another preferred embodiment of the present invention.

### DETAILED DESCRIPTION OF THE INVENTION

The present invention will be apparent from the following detailed description, which proceeds with reference to the accompanying drawings, wherein the same references relate to the same elements.

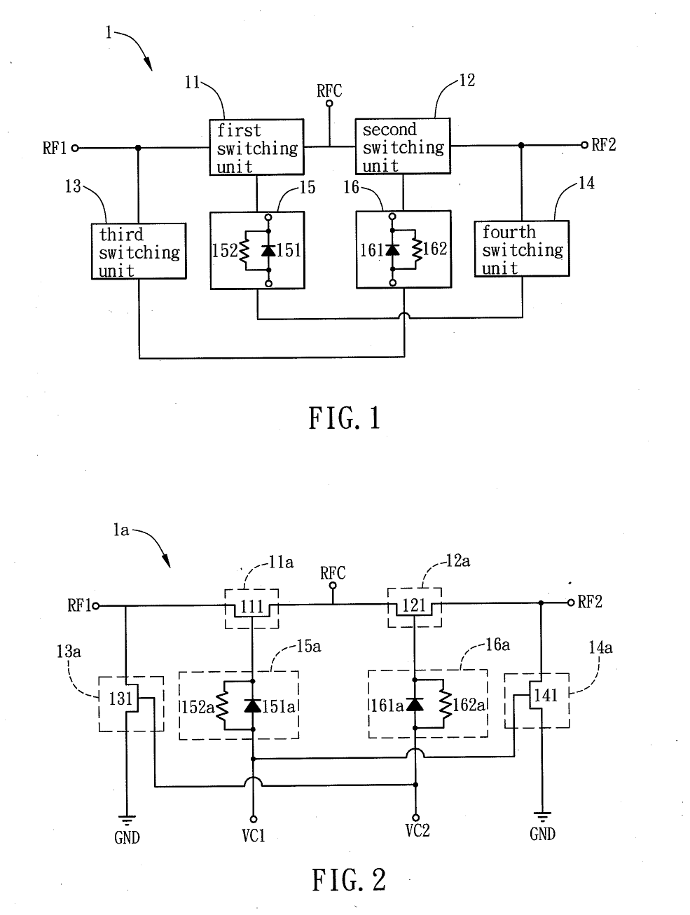

FIG. 1 is a circuit block diagram of a switching circuit 1 for an antenna according to a preferred embodiment of the present invention. Referring to FIG. 1, the switching circuit 1 includes a first switching unit 11, a second switching unit 12, a third switching unit 13, a fourth switching unit 14, a first clamping unit 15, and a second clamping unit 16.

The first switching unit 11 is coupled to a first signal terminal RF1 and a second signal terminal RFC.

The second switching unit 12 is coupled to the second signal terminal RFC and a third signal terminal RF2.

The third switching unit 13 is coupled to the first signal terminal RF1 and the first switching unit 11.

The fourth switching unit 14 is coupled to the third signal terminal RF2 and the second switching unit 12.

The first clamping unit 15 is coupled to the first switching unit 11 and the fourth switching unit 14. Besides, the first clamping unit 15 includes a first clamping device 151 and a first resistor 152, which are connected in parallel.

The second clamping unit 16 is coupled to the second switching unit 12 and the third switching unit 13. Besides, the second clamping unit 16 includes a second clamping device 161 and a second resistor 162, which are connected in parallel.

FIG. 2 is a circuit diagram of a switching circuit 1a for an antenna according to another preferred embodiment of the present invention. The switching circuit 1a is a detailed circuit layout for embodying the above switching circuit 1. Referring to FIG. 2, the switching circuit 1a includes a first switching unit 11a, a second switching unit 12a, a third switching unit 13a, a fourth switching unit 14a, a first clamping unit 15a, and a second clamping unit 16a.

In this embodiment, the first switching unit 11a, the second switching unit 12a, the third switching unit 13a, and the fourth switching unit 14a include a first switch device 111, a second switch device 121, a third switch device 131, and a fourth switch device 141, respectively. Each of the first switch device 111, the second switch device 121, the third switch device 131, and the fourth switch device 141 has a first terminal, a second terminal and a third terminal.

The first terminal of the first switch device 111 is coupled to the first signal terminal RF1, the second terminal of the first switch device 111 is coupled to the second signal terminal RFC and the second terminal of the second switch device 121, and the third terminal of the first switch device 111 is coupled to the first clamping unit 15a.

The first terminal of the second switch device 121 is coupled to the third signal terminal RF2, the second terminal of the second switch device 121 is coupled to the second signal terminal RFC and the second terminal of the first switch device 111, and the third terminal of the second switch device 121 is coupled to the second clamping unit 16a.

The first terminal of the third switch device 131 is coupled to the first signal terminal RF1 and the first terminal of the first switch device 111, the second terminal of the third switch device 131 is coupled to the second clamping unit 16a and a second power source VC2, and the third terminal of the third switch device 131 is coupled to a ground terminal GND.

The first terminal of the fourth switch device 141 is coupled to the third signal terminal RF2 and the first terminal of the second switch device 121, the second terminal of the fourth switch device 141 is coupled to the first clamping unit 15a and a first power source VC1, and the third terminal of the fourth switch device 141 is coupled to the ground terminal GND.

The first switch device 111, the second switch device 121, the third switch device 131 and the fourth switch device 141 can be all MEMS (Micro Electro Mechanical Systems) switches. In practice, the first switch device 111, the second switch device 121, the third switch device 131 and the fourth switch device 141 can be, for example but not limited to, NEMS (Nano Electro Mechanical Systems) switches.

The first clamping unit 15a includes a first clamping device 151a and a first resistor 152a. The first clamping device 151a is a Schottky diode. The cathode of the first clamping device 151a is coupled to a third terminal of the first switching unit 11a, and the anode of the first clamping device 151a is coupled to the fourth switching unit 14a and a first power source VC1. One end of the first resistor 152a is coupled to the cathode of the first clamping device 151a, and the other end of the first resistor 152a is coupled to the anode of the first clamping device 151a. That is, the first clamping device 151a and the first resistor 152a are connected in parallel. In practice, the first clamping device 151a may include a plurality of Schottky diodes, which are connected in series, and the first resistor 152a may include a plurality of resistors, which are connected in series or in parallel.

The second clamping unit 16a includes a second clamping device 161a and a second resistor 162a. The second clamping device 161a is a Schottky diode. The cathode of the second clamping device 161a is coupled to a third terminal of the second switching unit 12a, and the anode of the second clamping device 161a is coupled to the third switching unit 13a and a second power source VC2. One end of the second resistor 162a is coupled to the cathode of the second clamping device 161a, and the other end of the second resistor 162a is coupled to the anode of the second clamping device 161a. That is, the second clamping device 161a and the second resistor 162a are connected in parallel. In practice, the second clamping device 161a may include a plurality of Schottky diodes, which are connected in series, and the second resistor 162a may include a plurality of resistors, which are connected in series or in parallel.

The first signal terminal RF1 and the third signal terminal RF2 are the RF signal terminals with different operation frequencies. The first switching unit 11a and the second switching unit 12a are configured to switch to connect the second signal terminal with either the first signal terminal RF1 or the third signal terminal RF2, thereby switching the desired operation frequency. The first clamping unit 15a and the second clamping unit 16a are configured to improve the voltage-resistant level and anti-noise ability of the switching circuit 1a.

To be noted, the turn-on voltages of the first clamping device 151a and the second clamping device 161a and the resistances of the first resistor 152a and the second resistor 162a can be different based on the actual requirements. Besides, the circuit layouts of the first clamping unit 15a and the second clamping unit 16a can be, for example but not limited to, symmetrical or asymmetrical.

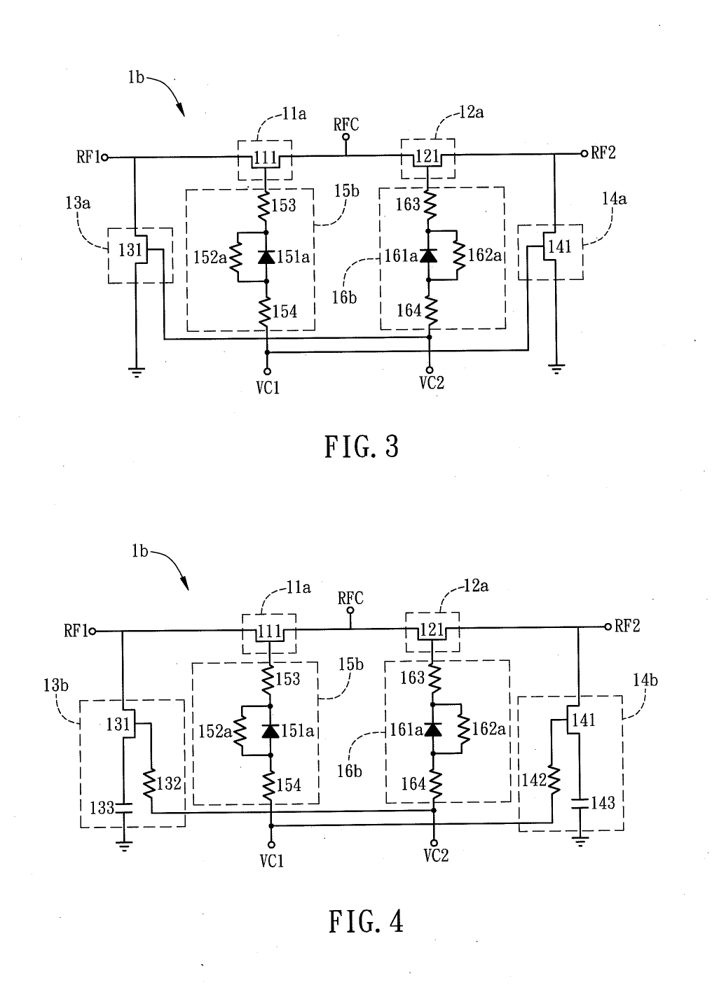

FIG. 3 is a circuit diagram of a switching circuit 1b for an antenna according to another preferred embodiment of the present invention. The circuit structure and operation theory of the switching circuit 1b are mostly the same as those of the above switching circuit 1a, and their different part will be described hereinafter while their similar part will be omitted.

In this embodiment, the first clamping unit 15b further includes a third resistor 153 and a fourth resistor 154.

A first terminal of the third resistor 153 is coupled to the first clamping device 151a (cathode) and the first resistor 152a, and a second terminal of the third resistor 153 is coupled to a third terminal of the first switching device 111.

A first terminal of the fourth resistor 154 is coupled to the first clamping device 151a (anode) and the first resistor 152a, and a second terminal of the fourth resistor 154 is coupled to a second terminal of the fourth switching device 141 and a first power source VC1.

In this embodiment, the second clamping unit 16b further includes a fifth resistor 163 and a sixth resistor 164.

A first terminal of the fifth resistor 163 is coupled to the second clamping device 161a (cathode) and the second resistor 162a, and a second terminal of the fifth resistor 163 is coupled to a third terminal of the second switching device 121.

A first terminal of the sixth resistor 164 is coupled to the second clamping device 161a (anode) and the second resistor 162a, and a second terminal of the sixth resistor 164 is coupled to a second terminal of the third switching device 131 and a second power source VC2.

To be noted, the resistances of the third resistor 153, the fourth resistor 154, the fifth resistor 163 and the sixth resistor 164 can be different based on the actual requirements, and this invention is not limited.

FIG. 4 is a circuit diagram of a switching circuit 1c for an antenna according to another preferred embodiment of the present invention. The circuit structure and operation theory of the switching circuit 1c are mostly the same as those of the above switching circuit 1b, and their different part will be described hereinafter while their similar part will be omitted.

In this embodiment, the third switching unit 13b further includes a seventh resistor 132 and a first capacitor 133.

A first terminal of the seventh resistor 132 is coupled to the third switching device 131, and a second terminal of the seventh resistor 132 is coupled to the sixth resistor 164 and the second power source VC2.

A first terminal of the first capacitor 133 is coupled to the third switching device 131, and the second terminal of the first capacitor 133 is coupled to the ground terminal GND.

In this embodiment, the fourth switching unit 14b further includes an eighth resistor 142 and a second capacitor 143.

A first terminal of the eighth resistor 142 is coupled to the fourth switching device 141, and a second terminal of the eighth resistor 142 is coupled to the fifth resistor 154 and the first power source VC1.

A first terminal of the second capacitor 143 is coupled to the fourth switching device 141, and the second terminal of the second capacitor 143 is coupled to the ground terminal GND.

In this embodiment, the turn-on voltage of the first clamping device 151a and the second clamping device 161a is 0.5V. The resistance of the first resistor 152a, the second resistor 162a, the third resistor 153, the fourth resistor 154, the fifth resistor 163, the sixth resistor 164, the seventh resistor 132, and the eighth resistor 142 is 10 k ohm. The capacitance of the first capacitor 133 and the second capacitor 143 is 1 pF. The voltage value of the first power source VC1 and the second power source VC2 is 3V. The operation frequency of the first signal terminal RF1 is 2.4 GHz, while the operation frequency of the third signal terminal RF2 is 5.8 GHz.

To be noted, the above values are examples only. In practice, the parameters of all devices, the resistance of the seventh and eighth resistors 132 and 142, and the capacitance of the first and second capacitors 133 and 143 can be varied depending on the actual requirements, and this invention is not limited.

In summary, the switching circuit for an antenna of the present invention includes a first clamping unit and a second clamping unit. Compared with the conventional art, the configuration of the first and second clamping units can improve the voltage-resistant level and anti-noise ability of the antenna switching circuit so as to improve the signal quality of the antenna, thereby bringing the extremely high marketing potential.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A switching circuit for an antenna, comprising:
a first switching unit coupled to a first signal terminal and a second signal terminal;
a second switching unit coupled to the second signal terminal and a third signal terminal;
a third switching unit coupled to the first signal terminal and the first switching unit;
a fourth switching unit coupled to the third signal terminal and the second switching unit;
a first clamping unit coupled to the first switching unit and the fourth switching unit, wherein the first clamping unit comprises a first clamping device and a first resistor, which are connected in parallel; and
a second clamping unit coupled to the second switching unit and the third switching unit, wherein the second clamping unit comprises a second clamping device and a second resistor, which are connected in parallel.

2. The switching circuit of claim 1, wherein the first switching unit comprises a first switch device having a first terminal coupled to the first signal terminal, a second terminal coupled to the second signal terminal, and a third terminal coupled to the first clamping unit.

3. The switching circuit of claim 1, wherein the second switching unit comprises a second switch device having a first terminal coupled to the third signal terminal, a second terminal coupled to the second signal terminal, and a third terminal coupled to the second clamping unit.

4. The switching circuit of claim 1, wherein the first clamping unit further comprises:
a third resistor having a first terminal coupled to the first clamping device and the first resistor, and a second terminal coupled to the first switching unit; and
a fourth resistor having a first terminal coupled to the first clamping device and the first resistor, and a second terminal coupled to the fourth switching unit.

5. The switching circuit of claim 4, wherein the second clamping unit further comprises:
a fifth resistor having a first terminal coupled to the second clamping device and the second resistor, and a second terminal coupled to the second switching unit; and
a sixth resistor having a first terminal coupled to the second clamping device and the second resistor, and a second terminal coupled to the third switching unit.

6. The switching circuit of claim 5, wherein the third switching unit comprises a third switch device, a seventh resistor and a first capacitor, and the third switch device has a first terminal coupled to the first signal terminal, a second terminal coupled to the sixth resistor and a second power source via the seventh resistor, and a third terminal coupled to a ground terminal via the first capacitor.

7. The switching circuit of claim 6, wherein the fourth switching unit comprises a fourth switch device, an eighth resistor and a second capacitor, and the fourth switch device has a first terminal coupled to the third signal terminal, a second terminal coupled to the fourth resistor and a first power source via the eighth resistor, and a third terminal coupled to the ground terminal via the second capacitor.

8. The switching circuit of claim 1, wherein each of the first clamping device and the second clamping device is a Schottky diode.
